(19) United States
(12) Patent Application Publication
(10) Pub. No.: US 2025/0136012 A1
(43) Pub. Date: May 1, 2025

(54) MULTI-USE ADAPTABLE HITCH-MOUNTED LOAD SUPPORT SYSTEM

(71) Applicant: Yakima Products, Inc., Lake Oswego, OR (US)

(72) Inventors: Scott A. McFadden, Portland, OR (US); Kevin Lesley, Beaverton, OR (US); Charles Kraeuter, Portland, OR (US); David Condon, Beaverton, OR (US); Ashley Hoch, Portland, OR (US); Marcos Henry Rodriguez, Portland, OR (US); Jason Attfield Sagen, Portland, OR (US); Brandon Michael Willems, Portland, OR (US); Craig DeAmbrose, Portland, OR (US)

(73) Assignee: Yakima Products, Inc., Lake Oswego, OR (US)

(21) Appl. No.: 18/908,567

(22) Filed: Oct. 7, 2024

Related U.S. Application Data
(63) Continuation of application No. 17/376,038, filed on Jul. 14, 2021, now abandoned.
(60) Provisional application No. 63/051,806, filed on Jul. 14, 2020.

(51) Int. Cl. B60R 9/10; B60D 1/58; B60R 9/06

(52) U.S. Cl. CPC B60R 9/10; B60D 1/58; B60R 9/06

(57) ABSTRACT

The disclosure relates to a multi-use adaptable hitch-mounted load support system. A vehicle rack system is disclosed, including a tongue portion configured to engage a hitch receiver behind a vehicle, and a lower crossbeam structure connected to the tongue portion. A lower end portion of a mast is connected to the lower crossbeam structure, and an upper crossbeam structure is connected to an upper end portion of the mast. A first pair of arms extend horizontally from the lower crossbeam structure, and a second pair of arms extend horizontally from the upper crossbeam structure. Each pair of arms is configured to support a recreational equipment carrier.

### CROSS-REFERENCES TO PRIORITY APPLICATIONS

This application is a continuation of U.S. patent application Ser. No. 17/376,038 filed Jul. 14, 2021 and published as U.S. Patent Publication No. 2022/0017020 on Jan. 20, 2022, which claims priority from U.S. Provisional Patent Application Ser. No. 63/051,806, filed Jul. 14, 2020. The complete disclosures of each application are hereby incorporated by reference in their entireties for all purposes.

### INTRODUCTION

A wide variety of sports and recreational activities require transport of equipment or cargo. Many single-use racks, boxes, supports, and other apparatus are available to allow transport by passenger car. A common style of rack attaches to a hitch receiver of the vehicle to transport equipment such as bicycles behind the vehicle. Hitch racks are particularly popular because the transported equipment is easily accessible for people of all sizes, and produces less wind resistance and noise compared to roof racks.

However, many recreational enthusiasts want to carry equipment for multiple sports and/or activities simultaneously, as well as to switch equipment between trips. For instance, such enthusiasts may transport bikes and camping equipment on one trip, and then ski gear on another trip. Thus, there is a need for a hitch-mounted vehicle rack system that is multi-use and adaptable.

### BRIEF DESCRIPTION OF THE DRAWINGS

FIG. 1 is an isometric view of an illustrative multi-use adaptable hitch-mounted load support system in accordance with aspects of the present disclosure, mounted on a vehicle in a illustrative configuration including a hitch rack, a bike rack secured to an upper level of the hitch rack, a cargo box secured to a lower level of the hitch rack, and an attached tow light assembly.

FIG. 2 is an isometric view of the lower level of the hitch rack of FIG. 1, in a closed position with arms in a collapsed position.

FIG. 3 is an isometric view of the upper and lower levels of the hitch rack of FIG. 1, with the lower level in the closed position with arms in an extended position.

FIG. 4 is an isometric view of the hitch rack of FIG. 1, with the lower level in an open position.

FIG. 5 is an isometric view of the pivotable bar and upper level of the hitch rack of FIG. 1, with the upper level in a 180 degree position.

FIG. 6 is an isometric top view of the upper level hitch rack of FIG. 1, with arms in an expanded position.

FIG. 7 is an exploded view of an arm pivot joint of the lower level of the hitch rack of FIG. 1.

FIG. 8 is a partially exploded view of the lateral member and the mast of the upper level of the hitch rack of FIG. 1.

FIG. 9 is an isometric rear view of the lateral member and the mast of the upper level of the hitch rack of FIG. 1, in the 0 degree position.

FIG. 10 is a cross-sectional view through an arm of the lower level of the hitch rack of FIG. 1, along line 10-10 in FIG. 3, with a secured recreational equipment carrier of the load support system.

FIG. 11 is another cross-sectional view through the arm of FIG. 10, taken in an orthogonal plane, along line 11-11 in FIG. 3.

FIG. 12 is an exploded view of the arm of FIG. 10, with the arm sleeve cut away along the cross-sectional plane of FIG. 11.

FIG. 13 is an isometric view of another illustrative configuration of the load support system of FIG. 1, with the bike rack secured to the upper level of the hitch rack.

FIG. 14 is an isometric view of another illustrative configuration of the load support system of FIG. 1, with a ski carrier secured to the upper level of the hitch rack.

FIG. 15 is an isometric view of another illustrative configuration of the load support system of FIG. 1, with a cargo basket secured to the lower level of the hitch rack.

FIG. 16 is an isometric view of another illustrative configuration of the load support system of FIG. 1, with a work surface secured to the upper level of the hitch rack.

FIG. 17 is an isometric view of another illustrative configuration of the load support system of FIG. 1, with the cargo box secured to the lower level of the hitch rack.

FIG. 18 is an isometric view from below the pivot joint of the lower level of the hitch rack of FIG. 1.

FIG. 19 is an exploded view of interchangeable components of a support jack of the load support system of FIG. 1.

FIG. 20 is an isometric view of the support jack supporting the pivot joint of the lower level of the hitch rack of FIG. 1.

FIG. 21 is an isometric view of another illustrative configuration of the load support system of FIG. 1, with the tow light assembly attached to the lower level of the hitch rack.

FIG. 22, is an isometric view of a left-hand light of the tow light assembly of FIG. 1, and the corresponding arm of the lower level of the load support apparatus of FIG. 1.

FIG. 23 is an isometric view of the cargo basket of the load support system of FIG. 1, converted for use as a cart.

FIG. 24 is an exploded isometric rear view of a rear wheel assembly of the converted cargo basket of FIG. 23.

FIG. 25 is an isometric rear view of a forward wheel assembly of the converted cargo basket of FIG. 23.

FIG. 26 is an isometric rear view of the rear wheel assembly of FIG. 24 mounted to the converted cargo basket of FIG. 23.

FIG. 27 is a partially exploded isometric front view of a front end and handle assembly of the converted cargo basket of FIG. 23.

### DETAILED DESCRIPTION

This disclosure provides numerous selected examples of a multi-use adaptable hitch-mounted load support system. Many alternatives and modifications which may or may not be expressly mentioned, are enabled, implied, currently possessed, and are supported by the disclosure. Unless otherwise specified, a multi-use adaptable hitch-mounted load support system in accordance with the present teachings, and/or its various components may, but are not required to, contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed examples. The following description of various examples is merely illustrative in nature and is in no way intended to limit the disclosure, its application, or uses. Additionally, the advantages provided by the examples described below are illustrative in nature and not all examples provide the same advantages or the same degree of advantages.

This Detailed Description includes the following sections, which follow immediately below: (1) Overview; (2) Examples, Components, and Alternatives; (3) Illustrative Combinations and Additional Examples; (4) Advantages, Features, and Benefits; and (5) Conclusion.

### Overview

In general, a multi-use adaptable hitch-mounted load support system may include a vehicle rack having an upper crossbeam structure and a lower crossbeam structure, connected by a mast. An upper end portion of the mast may be connected to the upper crossbeam structure and a lower end portion of the mast may be connected to the lower crossbeam structure. The system may also be described as a vehicle rack system, a rack for carrying recreational equipment on a vehicle, and/or a recreational equipment transport system.

A pair of arms may extend from each of the upper and lower crossbeam structures. Each pair of arms may extend horizontally from the respective crossbeam structure, to form a load support surface or structure. The support structures may also be described as tiers, decks, or levels. In some examples, the mast may be selectively removable, and the lower support structure may be used independently.

The vehicle rack of the load support system may further include a mounting structure appropriate for connection to a hitch receiver or tow hitch of a vehicle, such as a stinger or tongue portion with any appropriate lock, clamp, and/or securing mechanism. The arms of the upper and lower support structures may extend approximately parallel to the direction of travel of vehicle, when the rack is configured for transport. The arms may act similarly to crossbars of a roof rack, and a recreational equipment carrier of the load support system may be mounted between the arms, perpendicular to the direction of travel.

The rack of the load support system may also be configured to swing away from the rear of the vehicle, to allow access to the vehicle storage, and/or facilitate loading or unloading of the load support system. For example, the hitch mounting structure may be connected to the lower crossbeam structure, which may have a fixed portion and a pivoting portion. The mast and/or some or all of the arms may also be pivotable to facilitate loading, unloading, use, and/or storage.

Each arm of the rack may include a clamp device or clamping mechanism configured to allow easy tool-less connection of a variety of recreational equipment carriers of the load support system. A different carrier may be secured to each of the upper and lower support structures of the rack. Any carrier may be configured for use as part of the load support system by inclusion of a pair of cleats configured to be received by the clamping mechanisms of the upper or lower pair of arms.

Examples of recreational equipment carriers which may be included in the load support system include but are not limited to, bicycle racks, cargo boxes, cargo baskets, ski carriers, snowboard carriers, watercraft carriers, and fishing rod boxes. A recreational equipment carrier may be described as a rack or other supportive structure configured for a specific type of equipment. A recreational equipment carrier may additionally or alternatively be described as a rack, container, or supportive structure configured to directly or immediately contact the carried equipment. Carried equipment may be directly secured to a recreational equipment carrier by straps or clamps and/or may be contained in the recreational equipment carrier.

The load support system may also be used to transport and/or support equipment useful for camping and/or at a recreation site. For example, a tabletop, awning, portable camp shower, or grill may be included in the load support system and mountable to the rack. The load support system may further include equipment for transportation safety and/or ease. For example, the system may include a light extension assembly, a license plate mount, gear totes, or a kit including wheels to convert a cargo basket to a cart.

### Examples, Components, and Alternatives

The following sections describe selected aspects of exemplary multi-use adaptable hitch-mounted load supports as well as related systems and/or methods. The examples in these sections are intended for illustration and should not be interpreted as limiting the entire scope of the present disclosure. Each section may include one or more distinct examples, and/or contextual or related information, function, and/or structure.

### A. Illustrative Load Support System

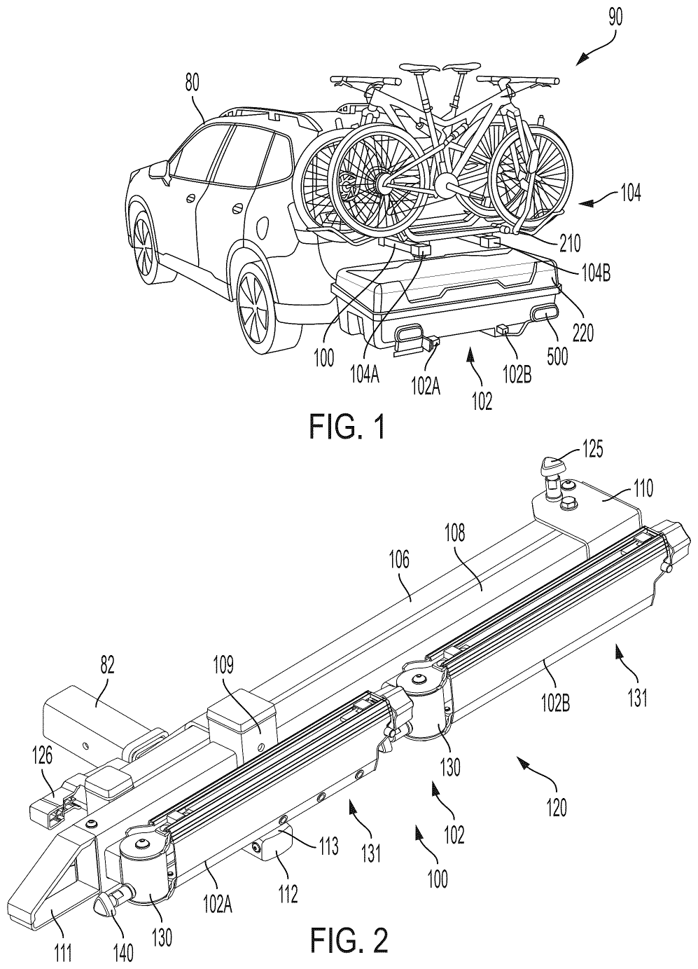

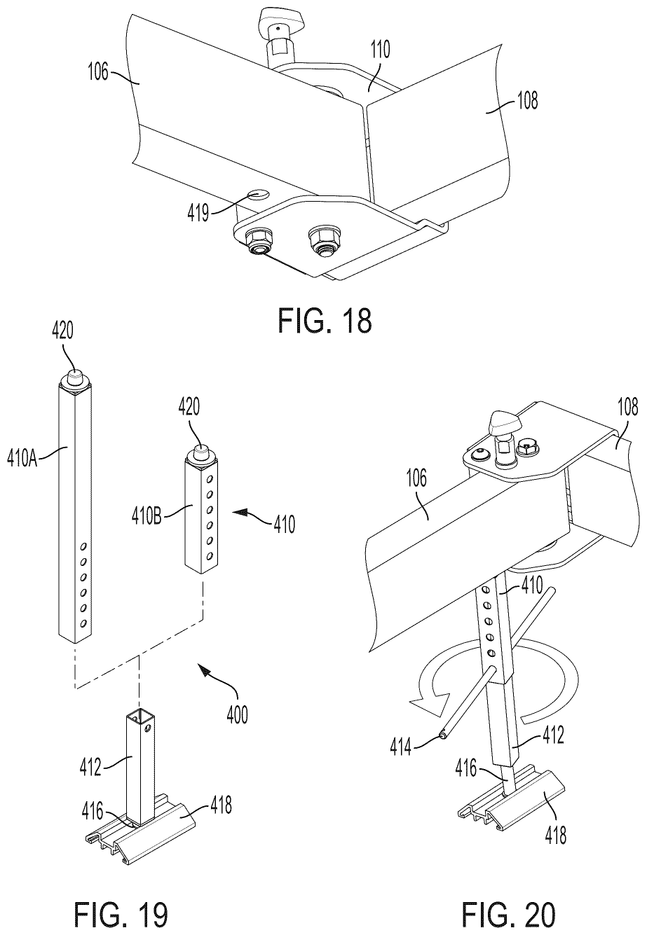

As shown in FIGS. 1-27, this section describes an illustrative multi-use adaptable load support system 90, including a hitch-mounted rack 100 and a plurality of recreational equipment carriers. Load support system 90 is an example of a multi-use load support system as described above.

FIG. 1 depicts load support system 90 installed on a vehicle 80. The vehicle may be described as defining a direction of travel, and as having a rear end. Rack 100 is mounted at the rear end of the vehicle, to support recreational equipment behind the vehicle. Elements of load support system 90 and rack 100 may be described in terms of a relationship to the direction of travel of vehicle 80, as forward or backward along the direction of travel, and/or as inboard or outboard relative to the vehicle. Such descriptions should be understood as describing position and orientation of the described elements when load support system 90 is installed on vehicle 80 and positioned for transport.

As illustrated in FIG. 1, rack 100 is configured to support two independent recreational equipment carriers of load support system 90 simultaneously. The rack includes a lower level 102 and an upper level 104. The lower level includes a first pair of arms 102A, 102B and the upper level includes a second pair of arms 104A, 104B. In the depicted illustrative configuration, a bike rack 210 is secured to arms 104A, 104B of the upper level, while a cargo box 220 is secured to arms 102A, 102B of the lower level.

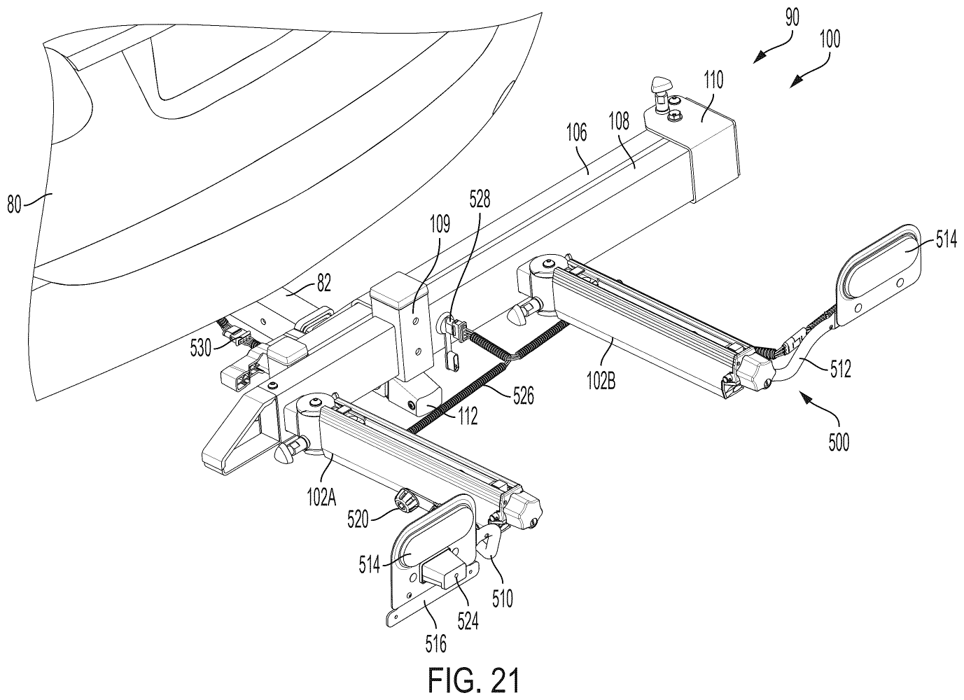

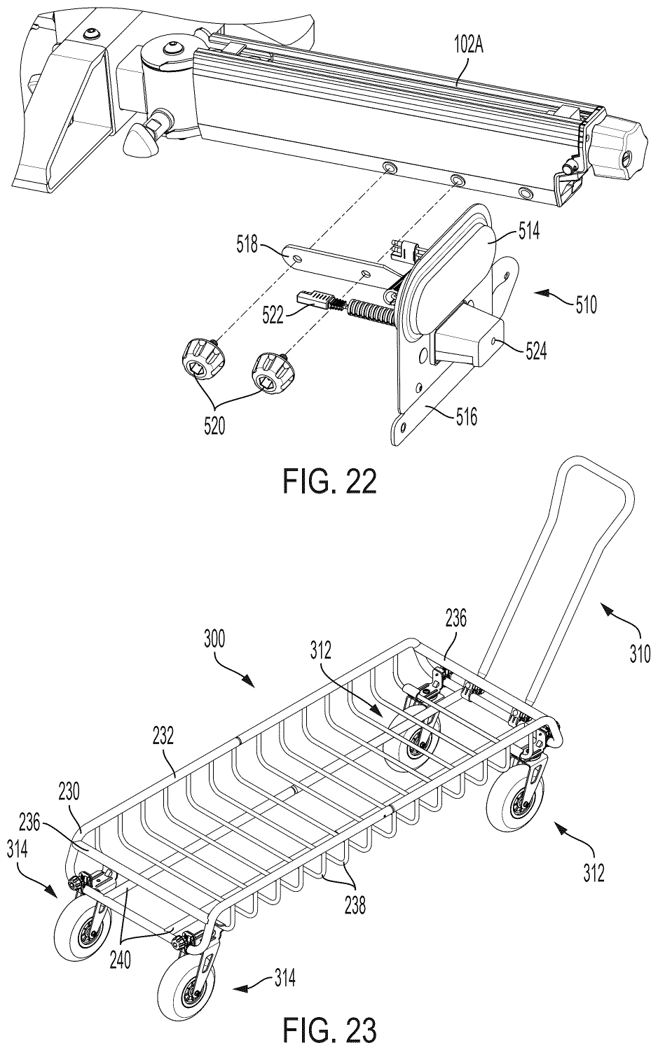

A light extension system 500 of load support system 90 is also installed in the illustrative configuration of FIG. 1. When installed on lower level 102 of rack 100, cargo box 220 may obstruct the taillights and/or license plate of vehicle 80. Accordingly, light extension system 500, as described further with reference to FIGS. 21 and 22 below, is mounted on lower level 102 and electrically connected to the vehicle.

A user of load support system 90 may interchange recreational equipment carriers as desired while leaving hitch rack 100 mounted to the vehicle hitch. A carrier may simply be unclamped from the arms of the load support, and another carrier clamped in place, as described further with reference to FIGS. 10-12, below. Equipment may be quickly and easily secured to the load support before travel to a recreation site, or as needed at a site. Further examples of carriers and equipment included in load support system 90 are shown in FIGS. 13-17.

FIG. 2 depicts lower level 102 of rack 100 mounted to a hitch receiver 82 of the vehicle. The lower level includes two arms 102A, 102B. The arms of the lower level are mounted to a lateral member or crossbeam structure consisting of a fixed bar 106 and a pivotable bar 108 connected by a pivot joint 110. More specifically, arms 102A, 102B are mounted to pivotable bar 108. In FIG. 2, rack 100 is in a closed position 120, with pivotable bar 108 parallel to fixed bar 106. Both bars are perpendicular to the vehicle direction of travel.

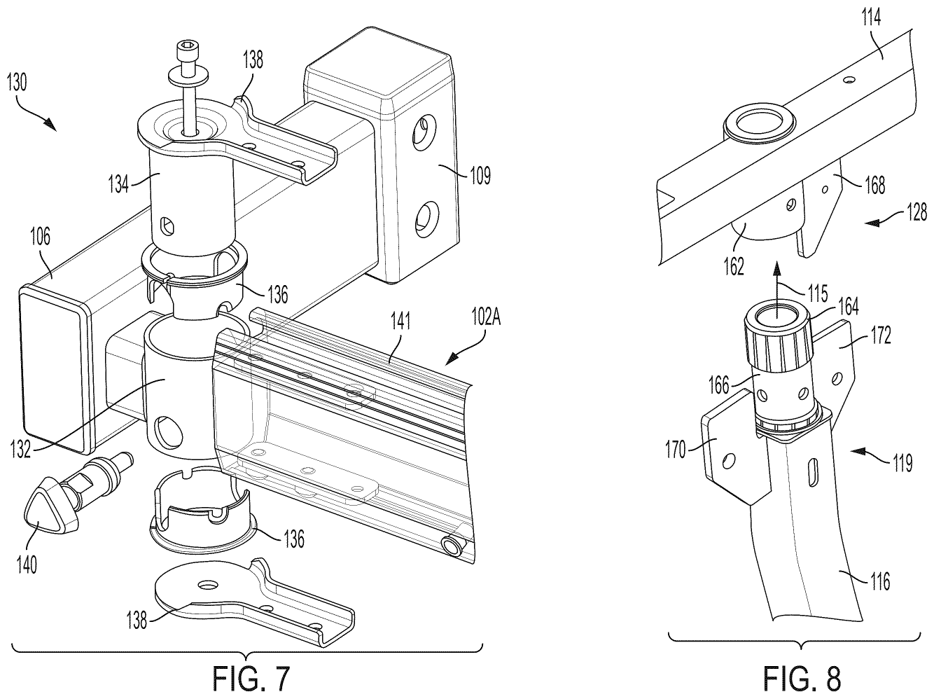

Arms 102A and 102B are each pivotably mounted to pivotable bar 108 by a joint 130. FIG. 7 is an exploded view of the components of joint 130 of arm 102A. Joint 130 may be understood as similarly constructed. Each joint includes an outer sleeve 132 fixed relative to pivotable bar 108, and an inner sleeve 134 fixed relative to the respective arm 102A, 102B. The inner and outer sleeves are rotatable relative to each other, on plastic bushings 136. Top and bottom end plates 138 secure the joint axially and fix inner sleeve 134 to the arm.

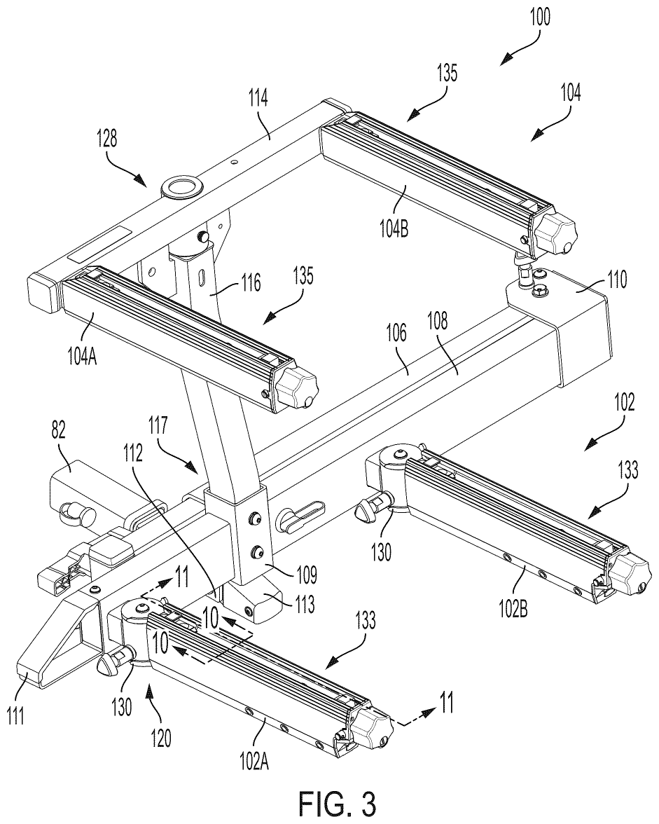

A spring pin 140 may engage one or more apertures in inner sleeve 134, defining positions of the arm. In the present example, each arm is pivotable between a collapsed position 131 as shown in FIG. 2 and an extended position 133 as shown in FIGS. 3-5. The arm positions may also be described as a use position and a stowed position, respectively.

In FIG. 2, lower level 102 is mounted alone, without the upper level and in a stowed configuration. More specifically, the lower level is in closed position 120 and arms 102A, 102B are both in collapsed position 131. This stowed configuration may be appropriate for operation of the vehicle when no recreational equipment is to be transported, but a user does not wish to uninstall the load support system.

Lower level 102 may also be used independently, with arms 102A, 102B in extended position 133. For example, the lower level may be used alone to support a cargo basket 230 or cargo box 220 as depicted in FIGS. 15 and 17, respectively.

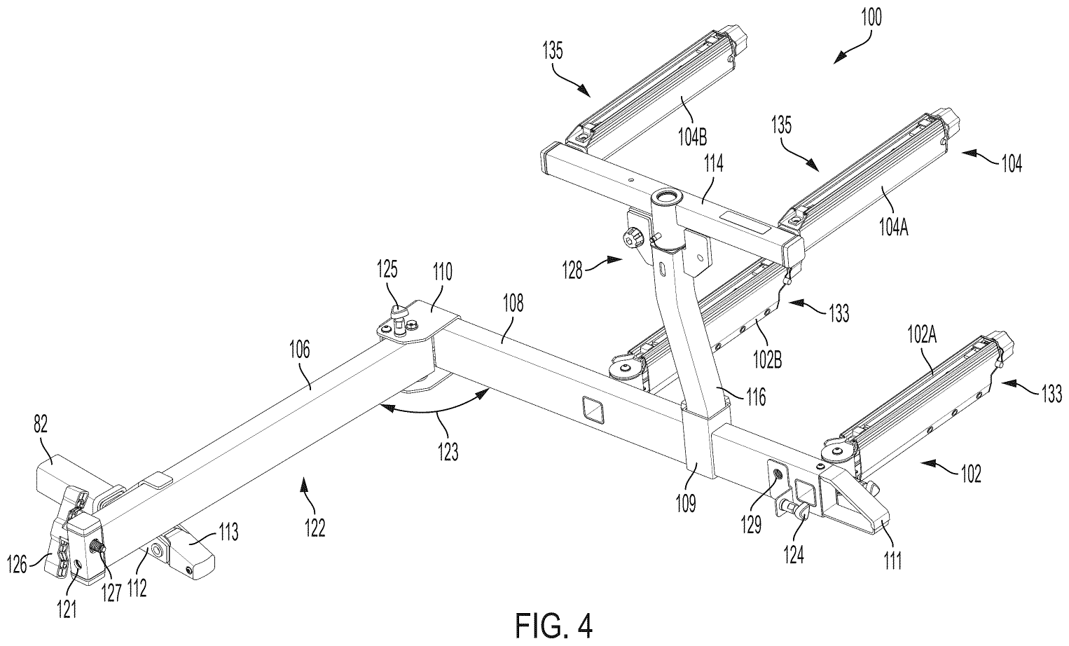

Rack 100 further includes a tongue portion or stinger 112, configured for connection to hitch receiver 82. The stinger is connected to fixed bar 106 by a bracket, to provide a solid load-bearing connection. The stinger is an approximately rectangular tubular member, which is received in hitch receiver 82 and extends through the connecting bracket, under pivotable bar 108. Stinger 112 includes a ramped distal or rear end 113, as more clearly shown in FIGS. 3 and 4.

FIG. 3 depicts upper level 104 of rack 100 installed on lower level 102. The upper level also includes two arms 104A, 104B. The arms extend from a lateral member 114 of the upper level, which is in turn mounted to an upper end portion of a mast 116. Lateral member 114 may also be described as a crossbeam structure. A lower end portion 117 of the mast is received in an attachment structure 109 of pivotable bar 108 and fastened to the attachment structure, thereby fixing the mast relative to the pivotable bar and supporting upper level 104. The fastener connection may be configured for selective, repeatable installation and removal of mast 116 and upper level 104 by a user, to allow independent use of lower level 102 as in FIG. 2 or concurrent use of the upper and lower levels as in FIGS. 3-5.

Stinger 112 extends under pivotable bar 108 immediately below mast 116. In this manner, the stinger may effectively transfer all loads from both upper level 104 and lower level 102 to the vehicle's hitch receiver.

As shown in FIGS. 3 and 4, rack 100 is transitionable between closed position 120, and an open position 122. The user may grasp a loop handle 111 fixed at an end of pivotable bar 108 distal of pivot joint 110, and pivot the bar around the pivot joint.

The closed position may be appropriate for equipment transport, when the vehicle is moving. The open position may be appropriate for equipment loading and unloading, accessing the rear of the vehicle, and use of the load support system as a work surface or other support, when the vehicle is stationary. In both positions, fixed bar 106 remains perpendicular to stinger 112, while pivotable bar 108 moves between positions. Fixed bar 106 may be described as fixed relative to stinger 112 and/or relative to the vehicle.

Stinger 112 may be parallel a longitudinal axis and/or the direction of travel of the vehicle. Fixed bar 106 may be described as defining a primary lateral axis of rack 100, and pivotable bar 108 may be described as defining a secondary lateral axis of the rack. The primary and secondary lateral axes may lie in a plane rotated relative to a horizontal plane of the vehicle, in both the closed and open positions. That is, rack 100 may be tilted to reduce or prevent sagging. In the present example, rack 100 has approximately a 1 degree tilt. In some examples, an angle of up to approximately 5 degrees may be appropriate.

In closed position 120, pivotable bar 108 is adjacent and parallel fixed bar 106. In open position 122 the pivotable bar forms an angle 123 with the fixed bar. Angle 123 is greater than 90 degrees, for instance between 95 and 110 degrees. In the present example, angle 123 is approximately 95 degrees. Pivot joint 110 has sufficient strength to support loaded equipment carriers on both the lower and upper levels of the load carrier in open position 122. For extended use in the open position, the pivot joint may be further supported by a jack, as further described with reference to FIGS. 18-20, below.

Arms 102A, 102B, 104A, 104B may be described as extending approximately horizontally. During transportation, in closed position 120 with arms 102A, 102B in extended position 133, all four arms may extend approximately parallel to the direction travel of the vehicle and perpendicular to the primary and secondary lateral axes of the rack. In the open position, the arms may remain perpendicular to the secondary lateral axis. Due to the tilt of the rack, the arms may be correspondingly tilted relative to stinger 112 and the direction of travel of the vehicle.

Pivotable bar 108 is securable in each of closed position 120 and open position 122. In the present example, the rack includes a first spring detent pin 124 at a distal end of pivotable bar 108. As the pivotable bar moves to the closed position, pin 124 may automatically engage an opening or detent 121 at a corresponding end of fixed bar 106. To more fully secure the bars together, the fixed bar includes a handle 126, which actuates a bolt 127 extending perpendicular to the fixed bar. A user may turn handle 126 in a first direction to advance the bolt to threadedly engage an aperture 129 in pivotable bar 108, and in an opposite direction to retract the bolt and release the pivotable bar.

Rack 100 further includes a second spring detent pin 125 at pivot joint 110. As pivotable bar 108 moves to the open position, pin 125 may automatically engage a detent or opening at a corresponding end of fixed bar 106. A user may lift pin 125 to release the pivotable bar, and return the rack to the closed position.

As pivotable bar 108 returns to the closed position, and underside of the bar may engage ramped end 113 of stinger 112. The ramp of the stinger may support and guide the pivotable bar into vertical alignment with fixed bar 106. Such support may correctly align bolt 127 with aperture 129 and spring detent pin 124 with detent 121, allowing the pivotable bar to be secured in the closed position without need for the user to lift pivotable bar 108 and any secured recreational equipment to achieve alignment.

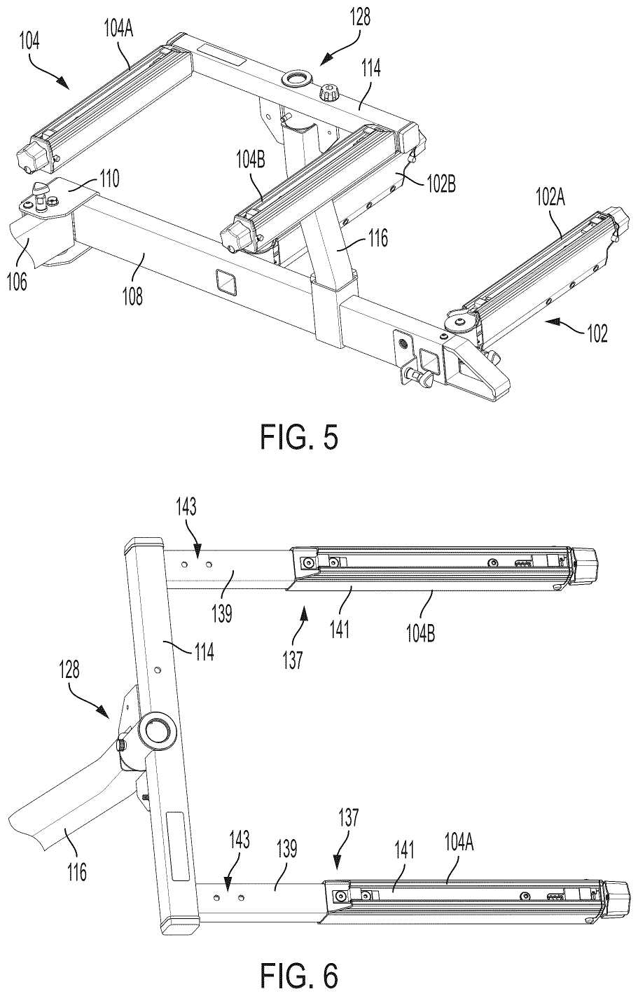

As shown in FIG. 5, upper level 104 is also rotatable. More specifically, lateral member 114 is joined to mast 116 by a rotatable joint 128. In the present example, the upper level is rotatable between two positions, a transport position as shown in FIGS. 3 and 4, and a 180 degree position as shown in FIG. 5. In some examples, the upper level may also be securable in an intermediate 90 degree position.

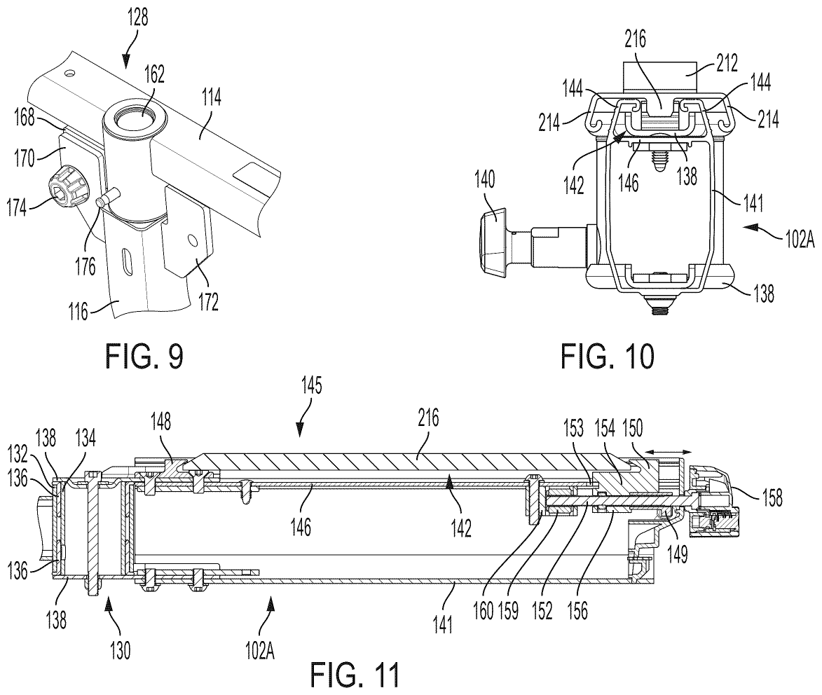

FIGS. 8 and 9 further depict a vehicle-facing side of rotatable joint 128, joining lateral member 114 and mast 116. In FIG. 8, the joint is partially exploded, showing an upper sleeve 162 fixed to a central portion of lateral member 114. The upper sleeve is configured to receive and engage a splined end 164 on a lower sleeve 166, of an upper end portion 119 of mast 116. The upper sleeve includes a single positioning aperture, while the lower sleeve includes two positioning apertures corresponding to the transport and 180 degree positions of the upper level.

Upper end portion 119 of mast 116 may define a longitudinal axis 115. The longitudinal axis may be approximately vertical. Joint 128 and/or lateral member 114 may be described as rotating about longitudinal axis 115.

Upper sleeve 162 includes a protruding plate or engaging fin 168 extending parallel lateral member 114 on one side. Mast 116 includes a first fin 170 and a second fin 172, extending from opposing lateral sides of the mast, proximate but spaced from lower sleeve 166. Each fin 168, 170, 172 includes an aperture.

In FIG. 9, joint 128 is depicted secured in transport position. The lower sleeve is received in upper sleeve 162, and engaging fin 168 is in contact with first fin 170. A fastener 174 extending through aligned apertures of the contacting fins secures the joint in position. A pin 176 inserted through aligned positioning apertures of the upper and lower sleeves further secures the joint. To retain pin 176 in place, a bridge or cotter pin may be used, or a locking mechanism may be installed.

To transition the upper level to the 180 degree position, a user may remove fastener 174 and pin 176. The user may then rotate lateral member and upper sleeve 162 until engaging fin 168 contacts second fin 172. The user then may reinsert fastener 174 through the aligned apertures of the contacting fins, and reinsert pin 176 through the aligned positioning apertures of the upper and lower sleeves.

In general, any effective rotatable and securable mechanism may be used for joint 128. Preferably, the joint may be sufficiently robust as to rotate while the upper level is under load, and may be sufficiently securable as to safely resist all loading during transport.

In the present example, arms 102A, 102B are pivotable between collapsed and extended positions, but arms 104A, 104B are fixed perpendicular to lateral member 114 of upper level 104. Instead, upper arms 104A, 104B are expandable. That is, the upper arms may be telescoped between a retracted position 135 shown in FIGS. 3-5, and an expanded position 137 shown in FIG. 6.

Each of arms 104A, 104B includes an arm frame member 139 received in an arm body 141. The arm frame member includes two sets of apertures 143 which can be used to fasten arm body 141 to the arm frame member, a proximal set of apertures corresponding to the retracted position and a distal set of apertures corresponding to the expanded position. A user may unfasten arm body 141 and withdraw arm frame member 139 to reach expanded position 137.

Expanded position 137 may provide additional distance or clearance between the rear of the vehicle and recreational equipment supported on upper level 104. For example, the expanded position may provide desired clearance between a rear window of the vehicle and handlebars of bikes secured to bike rack 210 on the upper level, as shown in FIG. 1. In general, some or all of arms 102A, 102B, 104A, 104B may be pivotable and/or extensible. The arms or other components may include any adjustable features appropriate to accommodate the dimensions or design of users' vehicles.

FIGS. 10 and 11 are orthogonal cross-sectional views of arm 102A, with a rail 212 of a recreational equipment carrier clamped to the arm. The cross section of FIG. 10 is taken through arm 102A along line 10-10 of FIG. 3, facing toward pivotable member 108. The cross section of FIG. 11 is taken through arm 102A, including joint 130, along line 11-11 of FIG. 3, facing inboard.

Rail 212 may be fixed to any recreational equipment carrier of load support system 90. That is, each recreational equipment carrier of the system includes a pair of rails fixed to an underside of the carrier, to facilitate attachment to arms of rack 100. Each of arms 102B, 104A, 104B may similarly engage secured recreational equipment carriers, and includes an arm body 141 with matching clamping structures.

As shown in FIG. 10, rail 212 engages a track 142 at a top surface of arm body 141. More specifically, as shown in FIG. 10, arm body 141 includes side walls 144 extending up from a top wall 146 to define track 142. Rail 212 includes side walls 214 overhanging arm body 141, and a central cleat 216 received in track 142.

As shown in FIG. 11, arm body 141 has a clamp 145, including a fixed wedge structure 148 at a first end of track 142, and a movable wedge structure 150 at a second end of the track. In arm 102B and depicted arm 102A, the first end of the track may be proximal to joint 130, and the second end may be distal from the joint. In arms 104A, 104B the first end may be proximal lateral member 114 (See FIG. 3) and the second end may be distal the lateral member. Cleat 216 includes complementary wedge-shaped first and second ends, configured to engage the fixed and movable wedge structures of clamp 145. To clamp the cleat and thereby secure the rail and attached carrier, movable wedge structure 150 may be urged along track 142 by a threaded rod or bolt 152, toward fixed wedge structure 148.

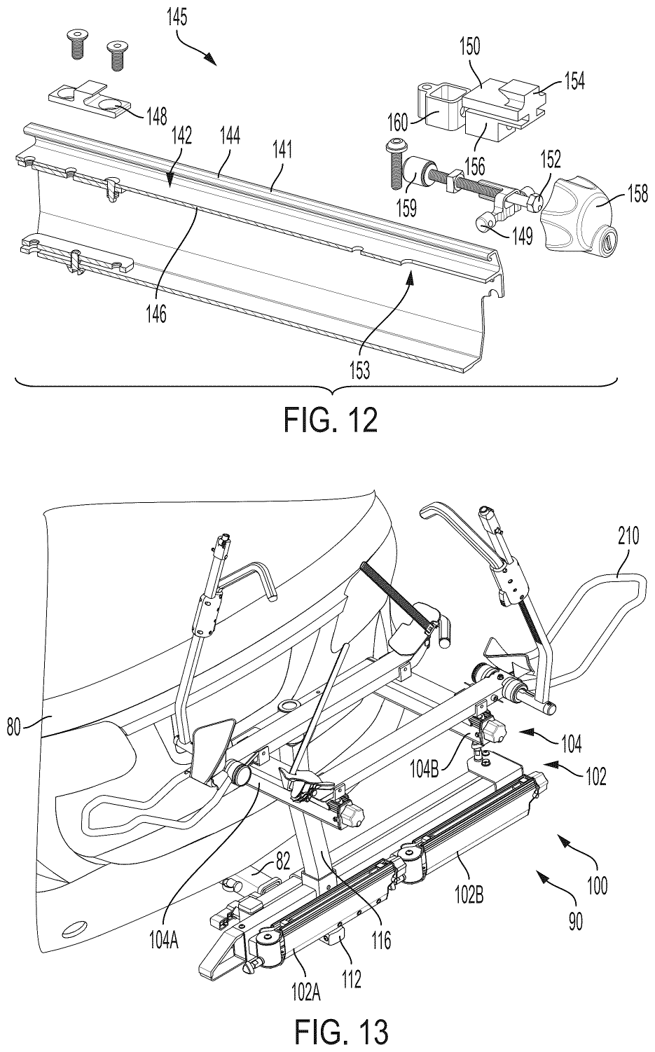

Movable wedge structure 150 extends through an elongate aperture 153 in top wall 146 of track 142. The aperture is shown more clearly in cut-away in FIG. 12. Movable wedge structure 150 has an upper portion 154 configured to engage the cleat and a lower portion 156 with a threaded aperture configured to receive and engage bolt 152. The elongate aperture in the top wall may limit motion of the wedge structure, and/or define a travel range of the wedge structure.

Bolt 152 extends horizontally and parallel arm body 141, from an actuating knob 158, through a supporting aperture in the distal end of the arm body, through movable wedge structure 150, to threadedly engage a lug 159 trapped in an aperture of an anchor 160. Anchor 160 is fixed to top wall 146, by a vertical bolt. The anchor may put bolt 152 in tension under load and axially secure the bolt, allowing movable wedge structure 150 to be driven in either direction along track 142.

Knob 158 engages a head of bolt 152, and is configured to allow a user to easily turn the bolt by hand. The user may thereby actuate the clamp 145. Knob 158 may include features such as a locking mechanism, grip, and radius appropriate to a desired mechanical advantage.

Clamp 145 further includes a latch structure 149 configured to selectively prevent or allow movement of bolt 152. The latch structure receives the bolt through a laterally elongate aperture, proximate the head of the bolt. A half-sleeve portion extends parallel bolt 152 from a first side of the elongate aperture. Latch structure 149 is horizontally movable along a direction perpendicular to bolt 152, between a latched position in which the bolt is proximate the first side of the elongate aperture and an unlatched position in which the bolt is proximate a second side of the elongate aperture.

In the latched position, the half-sleeve portion of the latch structure may contact threads of bolt 152, preventing rotation and advancement of the bolt. In the unlatched position, the latch structure may not contact the bolt or may contact only unthreaded portions of the bolt, permitting rotation and advancement of the bolt. In the present example, latch structure 149 includes a head portion at each of first and second ends. The head portions alternately protrude through corresponding apertures in arm body 141. A user may push or press whichever head portion is protruding to move the latch structure 149 and transition between the latched and unlatched positions.

In general, clamp 145 may include any appropriate anchor structure with a trapped lug or nut, or an integral threaded aperture. The anchor structure may be fixed relative to track 142 by fastening, bonding, welding, or any effective means. Movable wedge structure 150 may have any shape effective to engage both cleat 216 and driving bolt 152. In some examples, latch structure 149 may be omitted and the clamp may be secured by tightening and/or locking of knob 158 alone, or another latching mechanism may be included.

FIGS. 13-17 depict examples of recreational equipment carriers which may be included in load support system 90. In the depicted configurations, only a single recreational equipment carrier is secured. In general, the load support system may also be configured with any desired combination of two recreational equipment carriers on upper and lower levels.

Load support system 90 may include only some of the depicted carriers, and/or may include additional or alternative carriers. A user may add additional recreational carriers to the load support system as desired. In some examples, recreational carriers not included in load support system 90 may be adapted for use with the system by addition of rails as described with reference to FIGS. 10-12, above. In some examples, arms of rack 100 may be used as crossbars and recreational equipment and/or recreational equipment carriers may be clamped, tied, fastened, or secured to the rack in any safe and effective manner.

In the example of FIG. 13, bike rack 210 is secured to arms 104A, 104B of upper level 104 of rack 100. As described above, rails on bike rack 210 engage the clamping mechanisms of the arms of the upper level to secure the rack. In the present example, each rail spans between two bike mount trays of the rack allowing two bicycles to be carried perpendicular to the longitudinal axis of the vehicle and roughly parallel to the rear of the vehicle. Bike rack 210 may alternatively be secured to the lower level, but only loaded when the mast and upper level are removed in order to allow sufficient clearance for loaded bikes.

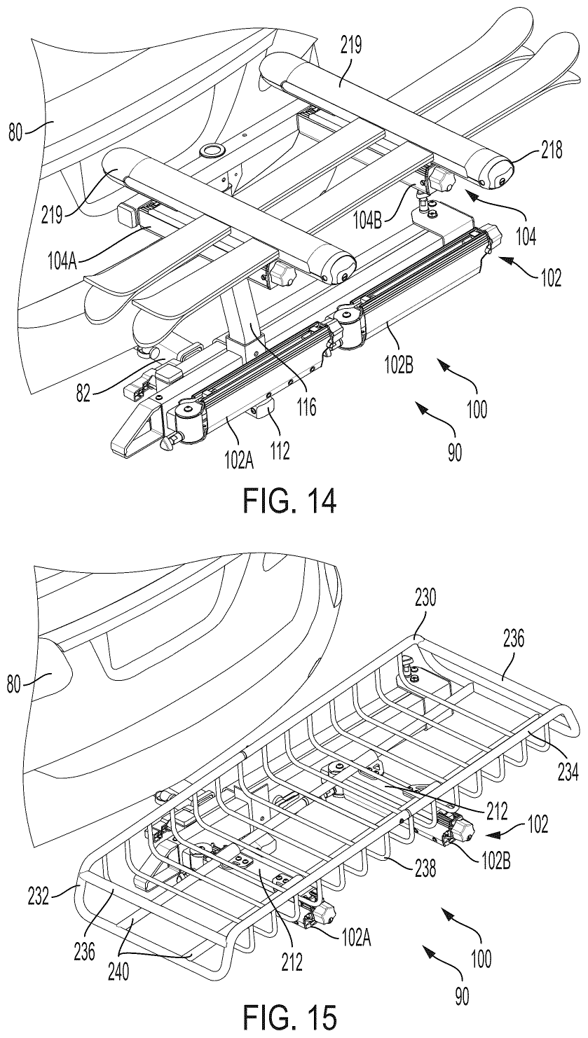

In the example of FIG. 14, a ski rack 218 is secured to arms 104A, 104B of upper level 104 of rack 100. Ski rack 218 includes first and second mounts 219. Each elongate mount includes a rail to secure the mount to a corresponding one of arms 104A, 104B. Skis, snowboards or similar equipment may be carried perpendicular to the longitudinal axis of the vehicle and roughly parallel to the rear of the vehicle, spanning between mounts 219. Ski rack 218 may alternatively be secured on the lower level.

In the example of FIG. 15, a cargo basket 230 is secured to arms 102A, 102B of lower level 102 of rack 100. The basket includes a perimetral rail 232 with parallel, opposing raised side portions 234. A crosspiece 236 is secured between the raised side portions at each of first and second ends of the cargo basket. A plurality of parallel u-shaped bars 238 extend longitudinally between the raised side portions, to form a floor of the basket along with a pair of lateral members 240. Each of two connector rails 212 is fastened to and supported between the pair of lateral rail members 240, to allow connection to the arms of the rack. Cargo basket 230 may alternatively be secured on the upper level.

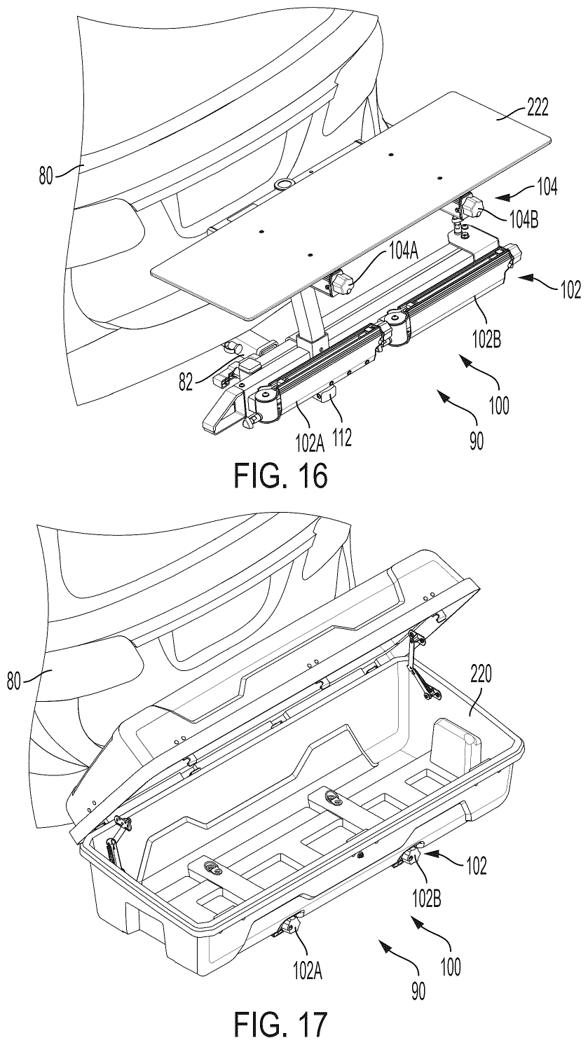

In the example of FIG. 16, a work surface 222 is secured to arms 104A, 104B of upper level 104 of rack 100. The work surface includes a planar expanse with a pair of rails secured to a lower surface (not shown). While work surface 222 is secured to upper level 104, the rack may be pivoted to the open position and the upper level rotated to the 180 degree position, to allow comfortable access to the work surface. Work surface 222 may alternatively be secured on the lower level, but may provide a comfortable working height for many users when secured on the upper level. In some examples, work surface 222 may include additional foldable supports to allow independent use as a camp table.

In the example of FIG. 17, a cargo box 220 is secured to arms 102A, 102B of the lower level of rack 100. The cargo box includes a main body with a pair of rails secured to a lower surface (not shown), and a hinged lid. The rails may be recessed into the lower surface of the box to maximize storage capacity of the box. Cargo box 220 may have a depth corresponding to a length or extent of arms 102A, 102B and a width corresponding to a standard or common vehicle width. Cargo box 220 may be used with upper level 104 installed, but in some examples may require the upper level to be rotated to the 180 degree position to provide clearance for the box lid to fully open. Cargo box 220 may alternatively be secured on the upper level.

FIGS. 18-20 depict an illustrative jack 400 of load support system 90. In some examples, jack 400 may be used with other racks and/or load support systems. A hitch-mounted rack pivoted away from the rear of a vehicle, such as rack 100 in open position 122 shown in FIG. 4, may tend to sag under heavy loading. To stabilize the rack and provide additional support during loading, unloading, or extended use in the open position, jack 400 may be positioned under the rack. A user may also thereby avoid any potential negative effects on components such as the pivot joint.

In general, jack 400 may include any expandable, telescoping, extensible, or otherwise adjustable components appropriate for support of rack 100. In the present example, as shown in FIG. 18, jack 400 includes a telescoping main body having an selectable upper portion 410 and a lower body portion 412. Based on the distance from the rack to the ground, a user may select a longer upper portion 410A or a shorter upper portion 410B. Each upper portion 410 includes an interface structure 420 at a top end. In the present example, interface structure 420 is a frustoconical boss.

The lower body portion may be partially received in the selected upper portion, and may slide to extend or retract the length of the jack. An aperture extends horizontally through lower body portion 412, to align with any one of a plurality of apertures extending horizontally through upper portion 410. Jack 400 further includes an ACME screw 416, shown more clearly in FIG. 20, connecting the lower body portion to a ground support or foot 418.

In the example depicted in FIGS. 18 and 20, jack 400 is positioned under fixed bar 106, proximate pivot joint 110. Fixed bar 106 includes a recess 419 on an underside or bottom surface, to engage and accurately position the jack. Recess 419 has a complementary shape to interface structure 420, and is configured to receive the interface structure.

In some examples, additional recesses may be provided under attachment structure 109 and/or the distal end of pivotable bar 108 (see FIG. 4). A user may then select a position for the jack to provide support or stability where it can be most effective, such as under the pivot joint or closer to a center of mass of loaded equipment. The user may also select a position for the jack based on ground conditions. A user may telescope the main body of the jack to an approximate desired length, and place foot 418 on the ground surface underneath the rack.

Once the jack is positioned under rack 100, a cylindrical handle 414 may be inserted through the aligned apertures, as shown in FIG. 20. The handle may retain the jack at a desired length, with the upper and lower portions in a desired relative position. The user may then fine tune the length of the jack and bring interface structure 420 at the top of the jack into recess 419, by rotating handle 414 to turn screw 416.

FIGS. 21 and 22 depict illustrative light extension system 500 of load support system 90. The system may also be described as tow lights. In some examples, light extension system 500 may be used and/or configured for use with other hitch-mounted load supports or racks. Many recreational equipment carriers, such as cargo box 220 shown in FIGS. 1 and 17, may block the tail lights and/or license plate of a vehicle when transported on a load support or rack such as rack 100. For safety, a driver of the vehicle may install light extension system 500.

Light extension system 500 includes two light assemblies, a first assembly 510 and a second assembly 512. Each of the light assemblies includes a light 514, and first assembly 510 further includes a license plate mount 516. The license plate mount includes a flat thermoplastic elastomer (TPE) plate and a pair of fasteners configured according to license plate mounting standards. The mount further includes a license plate light 524, positioned below light 514 and over the mounting plate to illuminate a mounted license plate.

As shown in FIG. 22, light assembly 510 includes a mounting arm 518 with a pair of fasteners 520. Fasteners 520 are configured to engage arm 102A of rack 100, such that mounting arm 518 extends past the distal end of the arm to position light 514 clear of carriers or equipment on the load support, as shown in FIG. 1. Fasteners 520 include knobs for manual use, to allow the assembly to be mounted to the arm without need for tools. Second light assembly 512 similarly includes a mounting arm and electrical connector, in a mirrored configuration for mounting on arm 102B of rack 100.

Each light assembly includes an electrical connector 522, as shown on first assembly 510 in FIG. 22. Electrical connector 522 of each light assembly connects to a wiring harness 526 of light extension system 500, as shown in FIG. 21. Two branches of wiring harness 526 extend from the light assemblies 510, 512 under arms 102A, 102B, to join and plug into an electrical connector or socket 528 on pivotable bar 108, proximate attachment structure 109. The wiring harness may be supported by clips, hangers, or other fasteners inserted in apertures on the underside of arms 102A, 102B.

Socket 528 is connected to internal wiring of rack 100, which extends out along pivotable bar 108 and back in along fixed bar 106. An electrical connector 530 of the rack extending from a vehicle-facing side of fixed bar 106 is configured for connection to an electrical system of the vehicle. Connector 530 may be a Society of Automotive Engineers (SAE) connector such as a 4-pin or 7-pin tow light, trailer, or taillight connector. Lights 514 may thereby be operatively and electrically connected to the vehicle.

Arms 102A, 102B may need to remain in the extended position while light extension system 500 is installed, to support wiring harness 526. However, connection through internal wiring of rack 100 may allow the rack to move between open and closed positions while the light extension system is installed. A user may also remove one fastener from the mounting arm of each light assembly 510, 512 to allow the light assemblies to temporarily pivot down away from arms 102A, 102B in order to provide clearance for attaching or removing a recreational equipment carrier.

FIGS. 23-27 depict an illustrative kit 300 of load support system 90, for converting cargo basket 230 to a cart. In some examples, kit 300 may be used and/or configured for use with other cargo baskets such as a basket configured for connection to a crossbar system or vehicle roof rack, and/or used to transport recreational equipment in any context.

Kit 300 includes a handle assembly 310 and four wheel assemblies, two forward wheel assemblies 312 and two rear wheel assemblies 314. In general, the handle assembly may be connected to any appropriate frame element of the cargo basket to define a desired forward end of the cart. Forward wheel assemblies may be mounted by any effective mechanism to any appropriate frame element or elements of the cargo basket, such as bars or rails of the floor of the cargo basket, proximate the defined forward end. The rear wheel assemblies may be similarly mounted proximate an opposing end.

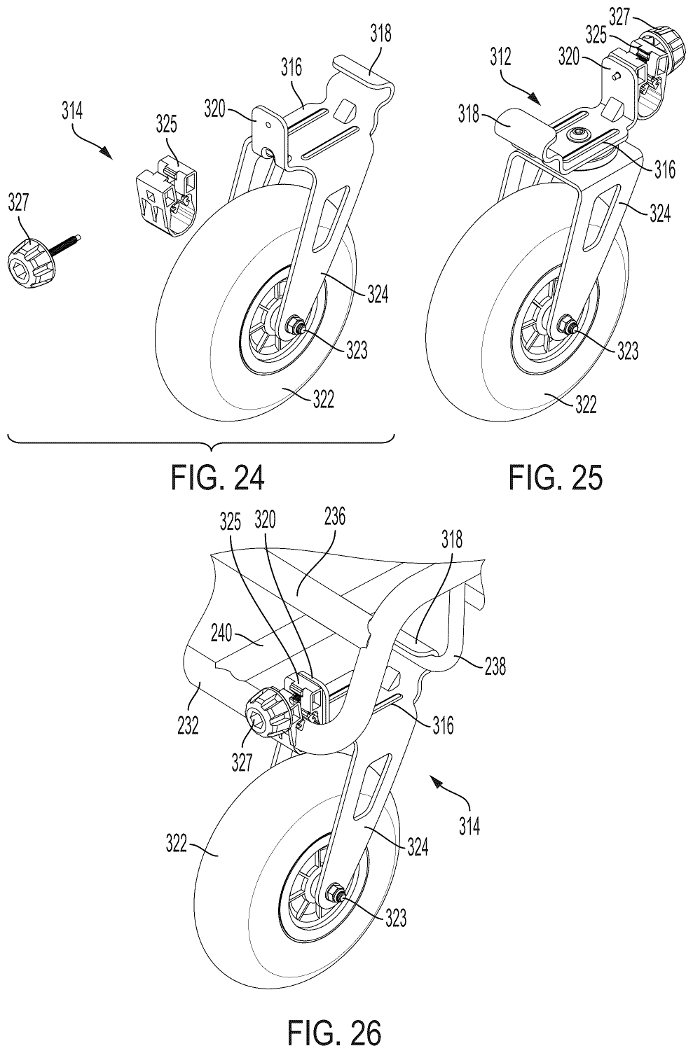

As shown in FIGS. 24 and 25, in the present example wheel assemblies 312, 314 each include a bracket 316 configured for mounting to two frame elements of the cargo basket. Each wheel assembly further includes a wheel 322 which turns on an axle 323 supported by a frame 324.

In forward wheel assemblies 312, as shown in FIG. 25, bracket 316 is pivotably mounted on a top planar surface of frame 324. Axle 323 of wheel 322 may thereby pivot relative to the cargo basket, which may facilitate steering of the cart by a user controlling the handle assembly. In rear wheel assemblies 314, as shown in FIG. 24, bracket 316 is integral with frame 324. Relative motion between the axle of wheel 322 and the cargo basket may be thereby prevented, which may also improve steering control of the cart.

Each bracket 316 includes a hook 318 at a first end and a vertical plate 320 at a second end. A band clamp 325 of each wheel assembly abuts vertical plate 320, and a fastener 327 extends through the band clamp and an aperture of the plate, to both tighten the band clamp and secure the band clamp to the plate. Fastener 327 includes a knob for manual use, to allow the assembly to be mounted to the basket without need for tools.

As shown in FIG. 26 for a rear wheel assembly 314, hook 318 of bracket 316 engages a longitudinal bar 238 of cargo basket 230 adjacent perimetral rail 232, while band clamp 325 engages the perimetral rail. Tightening the band clamp may draw the bracket tight to the rail, and secure hook 318 on the longitudinal bar. Forward wheel assemblies 312 similarly attach to the cargo basket, at an opposite end of the basket, in mirrored orientation.

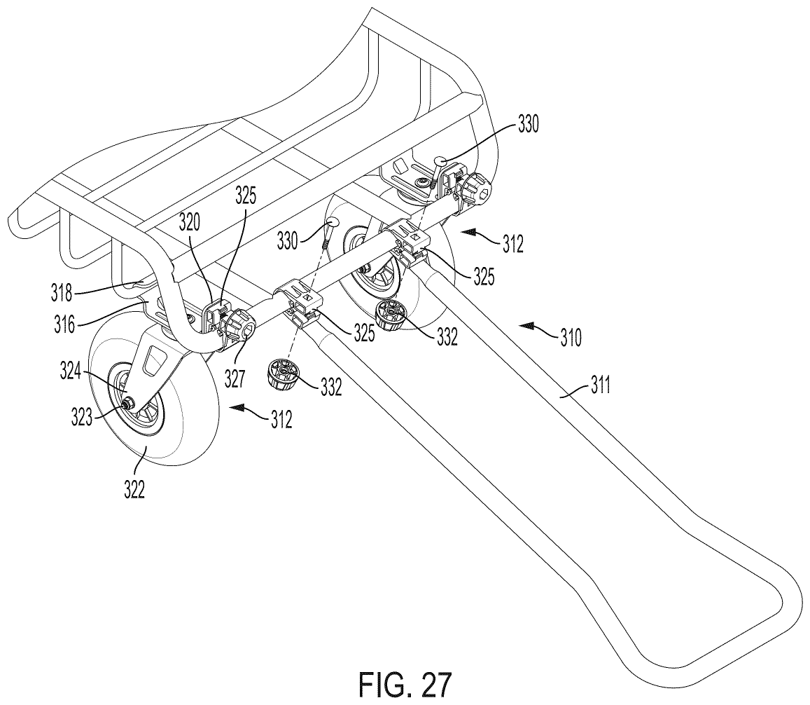

In the present example, handle assembly 310 includes an approximately u-shaped handle 311 with two end portions, and two band clamps 325. As shown in FIG. 27, each end portion of handle 311 is connected to perimetral rail 232 of cargo basket 230 by a band clamp 325, between forward wheel assemblies 312. A bolt 330 extends through each band clamp 325 and a corresponding aperture in an end portion of handle 311 to engage a knob 332. A user may manually tighten knob 332 to both engage the band clamp with the perimetral rail and secure the band clamp to the handle.

In some examples, some or all of the wheel assemblies may use other connecting mechanisms such as collet pins, clamps, or fasteners to attach to the cargo basket. In some examples, the cargo basket may include structures configured to engage the connecting mechanisms of the wheel assemblies, such as apertures, tubes, or recesses.

Preferably, the wheel assemblies and handle assembly may be attached to and removed from the basket without need for tools. Kit 300 may allow a user to transport cargo on a vehicle using rack 100 as described above, or other mounting systems such as crossbars and then subsequently attach kit 300 for transport of the cargo from the vehicle to a desired location.

For example, the cargo basket may be secured to rack 100 and sports equipment such as balls, nets, rackets, clubs, pads and/or sticks may be loaded for transport to a sports field. Upon arrival, the user may attach kit 300 to the cargo basket and then remove the basket from the rack. The converted basket may then be wheeled from the vehicle's location in a parking lot to appropriate locations around the sports field for unloading and equipment setup.

### Illustrative Combinations and Additional Examples

This section describes additional aspects and features of multi-use adaptable hitch-mounted load supports, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.
A0. A rack for carrying recreational equipment on a vehicle, comprising:

a tongue portion configured for attachment to a hitch receiver behind a vehicle,

a lower load support structure connected to the tongue portion and configured to support a first recreational equipment carrier; and

an upper load support structure connected to the lower support structure by a mast, and configured to support a second recreational equipment carrier.
A1. The rack of A0, wherein the lower load support structure includes first and second arms connected to a first lateral member, wherein the first lateral member is connected to the tongue portion and the first and second arms extend approximately parallel with the direction of vehicle travel.
A2. The rack of A1, wherein the first and second arms are rotatable relative to the first lateral member.
A3. The rack of A1 or A2, wherein the upper load support structure includes third and fourth arms connected to a second lateral member.
A4. The rack of A3, wherein the upper load support structure is rotatable relative to the mast.
A5. The rack of A4, wherein the upper load support structure is rotatable between a first position in which the third and fourth arms extend approximately parallel with the direction of vehicle travel, a second position in which the third and fourth arms extend approximately orthogonal to the direction of vehicle travel, and a third position opposite the first position.
A6. The rack of any of A3-A5, wherein each of the first, second, third, and fourth arms includes a clamp with first and second wedge structures, the first wedge structure being movable relative to the second wedge structure along the arm.
A7. The rack of any of A1-A6, wherein the first lateral member includes a fixed portion and a pivotable portion, the fixed portion being connected to the tongue portion and the pivotable portion being connected to the first and second arms.
A8. The rack of A7, wherein the lateral member has a first configuration in which the pivotable portion is parallel the fixed portion, and a second configuration in which the pivotable portion forms an angle between approximately 90 and 110 degrees with the fixed portion.
A9. The rack of A8, wherein the lateral member is selectively securable in the first configuration.
A10. The rack of any of A7-A9, further including a jack configured to engage a ground surface and an underside of the pivotable portion of the lateral member when the lateral member is in the second configuration.
A11. The rack of any of A7-A10, wherein the jack includes a telescoping main body.
A12. The rack of any of A7-A11, wherein the jack includes an ACME screw configured to extend and retract the jack while the jack is engaged with the ground surface and the underside of the pivotable portion of the lateral member.
A13. The rack of any of A0-A12, wherein the mast is selectively detachable from the lower load support structure.
A14. The rack of any of A0-A13, further including first and second tow light assemblies, each configured for operative connection to an electrical system of the vehicle.
A15. The rack of A14, wherein the first tow light assembly includes a mounting plate and fasteners configured to secure a license plate.
A16. The rack of A15, wherein the first tow light assembly further includes a light oriented to illuminate a secured license plate.
B0. A method of transporting recreational equipment,

attaching a load support to a hitch receiver of a vehicle;

clamping a first recreational equipment carrier to a lower pair of arms of the load support;

clamping a second recreational equipment carrier to an upper pair of arms of the load support;

loading the first and second recreational equipment carriers with recreational equipment.
B1. The method of B0, wherein the first recreational equipment carrier is one of (a) a cargo box, (b) a cargo basket, or (c) a ski carrier.
B2. The method of B0 or B1, wherein the second recreational equipment carrier is one of (a) a bike rack, (b) a cargo basket, or (c) a ski carrier.
B3. The method of any of B0-B2, wherein loading the first and second recreational equipment carriers includes rotating the upper pair of arms relative to the lower pair of arms, to access the first recreational equipment carrier.
B4. The method of any of B0-B3, wherein the upper and lower pair of arms are connected to a first lateral member of the load support, further including pivoting the first lateral member relative to a second lateral member connected to the hitch receiver, to access a rear of the vehicle.
B5. The method of B4, further including positioning a jack under the pivoted first lateral member and raising the jack to support the first lateral member and connected upper and lower pairs of arms, first and second recreational equipment carriers, and loaded recreational equipment.
B6. The method of B4 or B5, further including:

unloading the second recreational equipment carrier;

unclamping the second recreational equipment carrier;

clamping a planar expanse to the upper pair of arms of the load support; and

using the planar expanse and the load support as a table.
B7. The method of any of B0-B6, further including:

removing a license plate from the vehicle;

mounting a first tow light assembly to one of the lower pair of arms of the load support;

mounting a second tow light assembly to the other of the lower pair of arms of the load support;

electrically connecting the first and second tow light assemblies to the vehicle; and

fastening the license plate to the first tow light assembly.
C0. A recreational equipment transport system, comprising:

a tongue portion configured for attachment to a hitch receiver behind a vehicle,

a first lateral member connected to the tongue portion, and

first and second arms extending from the first lateral member, approximately parallel with the direction of vehicle travel,

wherein each arm includes a clamp with first and second wedge structures, the first wedge structure being movable relative to the second wedge structure along the arm.
C1. The system of C0, further including a bike rack having first and second cleats, each cleat being configured to be received and secured by a clamp of the first or second arm.
C2. The system of C0 or C1, further including a pair of supports forming a ski rack, each support including a cleat configured to be received and secured by a clamp of the first or second arm.
C3. The system of any of C0-C2, further including a cargo box having first and second cleats, each cleat being configured to be received and secured by a clamp of the first or second arm.
C4. The system of any of C0-C3, further including a cargo basket having first and second cleats, each cleat being configured to be received and secured by a clamp of the first or second arm.
C5. The system of any of C0-C4, further including a table top having first and second cleats, each cleat being configured to be received and secured by a clamp of the first or second arm.
C6. The system of any of C0-C5, further including third and fourth arms connected to a second lateral member, the second lateral member being connected to the first lateral member by a mast.
D0. A connection system for mounting a recreational equipment rack to a load support, comprising:

an arm of a load support mounted to a hitch receiver of a vehicle, including:

a fixed wedge structure,

a movable wedge structure, and

an actuator including a threaded rod engaging the movable wedge structure and a knob configured for manual rotation of the threaded rod,

wherein rotating the knob in a first direction advances the movable wedge structure toward the fixed wedge structure and rotating the knob in a second direction retreats the movable wedge structure away from the fixed wedge structure; and

a rail fixed to a recreation equipment rack and including a cleat structure, the cleat structure having first and second sloped surfaces complementary to the fixed wedge structure and the movable wedge structure;

wherein the cleat structure of the rail is configured to be received in the arm and clamped between the fixed wedge structure and the movable wedge structure.
D1. The system of D0, wherein the fixed wedge structure and an upper portion of the movable wedge structure are disposed in a track of the arm, the track being configured to receive the cleat structure of the rail.
D2. The system of D1, wherein the threaded rod engages a lower portion of the movable wedge structure, the threaded rod and the lower portion being disposed in an interior space of the arm, adjacent the track.
D3. The system of D1 or D2, further including an anchor structure disposed in the interior space and fixed to the track, a distal end of the threaded rod being received in the anchor structure.
D4. The system of any of D0-D3, further including an anchor structure fixed to the arm, a distal end of the threaded rod being received in the anchor structure.
E0. A method of attaching a recreational equipment carrier to a load support, comprising:

inserting a cleat of a recreational equipment carrier into a track of an arm of a load support;

manually turning a knob of the arm to rotate a threaded rod and thereby urge a first wedge structure at a first end of the arm toward a second wedge structure fixed at a second end of the arm;

clamping the cleat of the recreational equipment carrier between the first and second wedge structures.
F0. A kit for converting a cargo basket into a cart, the kit comprising:

a plurality of wheel assemblies, each including a connecting bracket having a hook portion and a clamp portion, and a wheel having an axle; and

a handle assembly including a clamp at a first end and a handle at a second end;

wherein the axle of the wheel of a first one of the wheel assemblies is pivotably mounted to the corresponding connecting bracket, and the axle of the wheel of a second one of the wheel assemblies is fixedly mounted to the corresponding connecting bracket.
G0. A convertible cargo basket, comprising:

a cargo basket configured for mounting to a vehicle, including a perimetral rail having parallel raised side portions and a plurality of spaced apart parallel longitudinal members connected to the rail;

a forward wheel assembly including a first wheel having a first axle, the forward wheel assembly configured for connection to the cargo basket such that the first axle is pivotable relative to the cargo basket,

a rear wheel assembly including a second wheel having a second axle, the rear wheel assembly configured for connection to the cargo basket such that the second axle is fixed relative to the cargo basket,

a handle assembly including a clamp configured to engage a first one of the plurality of longitudinal members of the cargo basket at a first end and a handle at a second end.
H0. A method of converting a cargo basket to a cart, comprising:

clamping a first end of a handle assembly to a cargo basket;

connecting a first wheel assembly to the cargo basket, including:

hooking a first end of a connecting bracket of the wheel assembly to a longitudinal member of the cargo basket; and

clamping a second end of the connecting bracket of the wheel assembly to a perimetral rail of the cargo basket.
H1. The method of H0, further including removing the cargo basket from a vehicle.
H2. The method of H0 or H1, wherein clamping the second end includes urging the second end toward the first end.
H3. The method of any of H0-C2, wherein the first wheel assembly includes an axle that is pivotable relative to the connecting bracket.
H3. The method of H3, further including connecting a second wheel assembly to the cargo basket, the second wheel assembly including a connecting bracket and an axle that is fixed relative to the connecting bracket.
H4. The method of any of H0-H3, wherein connecting a first wheel assembly includes connecting the first wheel assembly to a first end of the cargo basket, and the method further includes connecting a second wheel assembly to the first end of the cargo basket and connecting third and fourth wheel assemblies to a second, opposing end of the cargo basket.
J0. A recreational equipment transport system, comprising:

a tongue portion configured for attachment to a hitch receiver behind a vehicle,

a lower load support structure connected to the tongue portion;

an upper load support structure connected to the lower support structure by a mast;

a first recreational equipment carrier, supported on the lower load support structure; and

a second recreational equipment carrier, supported on the upper load support structure.
J1. The system of J0, wherein the lower load support structure includes first and second arms connected to a first lateral member, wherein the first lateral member is connected to the tongue portion and the first and second arms extend approximately parallel with the direction of vehicle travel.
J2. The system of J1, wherein the upper load support structure includes third and fourth arms connected to a second lateral member.
J3. The system of J2, wherein in each of the first, second, third, and fourth arms includes a clamp with first and second wedge structures, the first wedge structure being movable relative to the second wedge structure along the arm.
J4. The system of J3, wherein each of the first and second recreational equipment carriers includes first and second cleats, each cleat being configured to be received by the clamp of one of the arms.
J5. The system of J1, wherein the first lateral member includes a fixed portion and a pivotable portion, the fixed portion being connected to the tongue portion and the pivotable portion being connected to the first and second arms.
J6. The system of J5, further including a jack configured to engage a ground surface and an underside of the pivotable portion of the lateral member when the lateral member is in the second configuration.
J7. The system of J0, further including first and second light assemblies, each configured for operative connection to an electrical system of the vehicle.
J8. The system of J0, wherein either the first or the second recreational equipment carrier is a cargo basket, and further including a plurality of wheel assemblies and a handle assembly configured for mounting to the cargo basket.
K0. A method of transporting recreational equipment,

attaching a tongue portion of a load support system to a hitch receiver of a vehicle;

clamping a first recreational equipment carrier to first and second arms of a lower support structure of the load support;

clamping a second recreational equipment carrier to third and fourth arms of an upper support structure of the load support;

loading the first and second recreational equipment carriers with recreational equipment.
L0. A vehicle rack system, comprising:

a tongue portion configured to engage a hitch receiver behind a vehicle,

a lower crossbeam structure connected to the tongue portion,

a mast having a lower end portion and an upper end portion, the lower end portion of the mast being connected to the lower beam structure,

an upper crossbeam structure connected to the upper end portion of the mast,

a first pair of arms extending horizontally from the lower crossbeam structure,

a second pair of arms extending horizontally from the upper crossbeam structure, each pair of arms configured to support a recreational equipment carrier.
L1. The vehicle rack system of L0, wherein the lower crossbeam structure has a fixed portion and a pivoting portion, the first pair of arms being connected to the pivoting portion of the lower crossbeam structure.
L2. The vehicle rack system of L1, wherein the mast extends upward from the pivoting portion of the lower crossbeam structure.
L3. The vehicle rack system of any of L0-L2, wherein the upper end portion of the mast has a longitudinal axis, the upper crossbeam structure being rotatable around the longitudinal axis of the mast.
L4. The vehicle rack system of any of L0-L3, wherein each of the first pair of arms is pivotable between a use position perpendicular to the lower crossbeam structure and a stowed position parallel to the lower crossbeam structure.
L5. The vehicle rack system of any of L0-L4, wherein each of the arms has a clamp device for securing a recreational equipment carrier to the respective arm.

### Advantages, Features, and Benefits

The different examples of the multi-use adaptable hitch-mounted load support systems, components, and methods described herein provide several advantages over known solutions for transporting recreational equipment. For example, illustrative examples described herein allow two recreational equipment carriers to be supported from a single vehicle hitch.

Additionally, and among other benefits, illustrative examples described herein allow transition between single and dual-level configurations.

Additionally, and among other benefits, illustrative examples described herein allow tool-less installation and removal of recreational equipment carriers.

Additionally, and among other benefits, illustrative examples described herein allow use of a variety of recreational equipment carriers, suitable for a range of recreational equipment.

Additionally, and among other benefits, illustrative examples described herein allow access to the rear of a vehicle without removal of the load support system.

Additionally, and among other benefits, illustrative examples described herein allow the load support system to be stowed when not in use, without disconnection from the vehicle hitch.

Additionally, and among other benefits, illustrative examples described herein allow access to a recreational equipment carrier on a lower level while a recreational equipment carrier is installed on an upper level.

Additionally, and among other benefits, illustrative examples described herein allow adjustment to ensure clearance of supported recreational equipment from the rear of the vehicle.

Additionally, and among other benefits, illustrative examples described herein allow stabilization of the load support system in an open position for extended periods.

Additionally, and among other benefits, illustrative examples described herein allow safe operation of the vehicle even if tail lights and/or license plate are obscured by secured recreational equipment and/or carriers.

Additionally, and among other benefits, illustrative examples described herein facilitate further transport of equipment carried on the load support system by converting a cargo basket of the system into a wheeled cart.

Additionally, and among other benefits, illustrative examples described herein are robust and easy to install, reconfigure, and use in a wide variety of configurations for transportation of multiple types of recreational equipment or large volumes of equipment.

Additionally, and among other benefits, illustrative examples described herein allow transport of equipment with less noise and impact on fuel efficiency than roof racks.

No known system or device can perform these functions, particularly in a hitch-mounted position. Thus, the illustrative examples described herein are particularly useful for vehicles without roof racks. However, not all examples described herein provide the same advantages or the same degree of advantage.

### Conclusion

It is believed that the disclosure set forth herein encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the disclosure includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

The various structural members disclosed herein may be constructed from any suitable material, or combination of materials, such as metal, plastic, nylon, plastic, rubber, or any other materials with sufficient structural strength to withstand the loads incurred during use. Materials may be selected based on their durability, flexibility, weight, and/or aesthetic qualities.

Although the present disclosure has been provided with reference to the foregoing operational principles and embodiments, it will be apparent to those skilled in the art that various changes in form and detail may be made without departing from the spirit and scope of the disclosure. The present disclosure is intended to embrace all such alternatives, modifications and variances. Where the disclosure recites “a,” “a first,” or “another” element, or the equivalent thereof, it should be interpreted to include one or more such elements, neither requiring nor excluding two or more such elements. Furthermore, any aspect shown or described with reference to a particular embodiment should be interpreted to be compatible with any other embodiment, alternative, modification, or variance.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

1-20. (canceled)

21. A rack for carrying recreational equipment on a vehicle, comprising:
a stinger receivable by a hitch receiver behind a vehicle;
a fixed bar extending perpendicular to the stinger, and fixed to the stinger;
a pivotable bar, having a first end connected to the fixed bar by a pivot joint, wherein a second end of the pivotable bar is releasably securable to the fixed bar when the pivotable bar is in a closed position;
a first pair of arms, extending from the pivotable bar and configured to support a first recreational equipment carrier; and
a socket fixed to the pivotable bar between the first pair of arms.

22. The rack of claim 21, further including
a mast, having a lower end portion fastenable in the socket of the pivotable bar;
a crossbar mounted to a top end portion of the mast; and
a second pair of arms, extending from the crossbar and configured to support a second recreational equipment carrier.

23. The rack of claim 21, wherein the stinger extends under the fixed bar, and when the pivotable bar is in the closed position, the pivotable bar is horizontally adjacent and parallel the fixed bar.

24. The rack of claim 23, wherein a first end of the stinger is configured for attachment to a hitch receiver and a second end of the stinger is ramped.

25. The rack of claim 24, wherein the second end of the stinger extends under the pivotable bar and a lower end portion of the mast when the pivotable bar is in the closed position.

26. The rack of claim 21, wherein each of the first pair of arms extends from a rear face of the pivotable bar.

27. A rack for carrying recreational equipment on a vehicle, comprising:
a stinger receivable by a hitch receiver behind a vehicle;
a fixed bar extending perpendicular to the stinger, and fixed to the stinger;
a pivotable bar, having a first end connected to the fixed bar by a pivot joint, wherein a second end of the pivotable bar is releasably securable to the fixed bar when the pivotable bar is in a closed position;
a first pair of arms, extending from the pivotable bar and configured to support a first recreational equipment carrier;
a mast, having a lower end portion connected to the pivotable bar;
a crossbar mounted to a top end portion of the mast; and
a second pair of arms, extending from the crossbar and configured to support a second recreational equipment carrier.

28. The rack of claim 27, wherein:
the lower end portion of the mast is connected to the pivotable bar between the first pair of arms.

29. The rack of claim 27, wherein the mast is non-linear.

30. The rack of claim 27, wherein the lower end portion and the top end portion of the mast are each linear.

31. The rack of claim 27, wherein each arm of the first pair of arms is pivotably connected to the pivotable bar by a joint.

32. The rack of claim 27, wherein each arm of the second pair of arms is expandable.

33. The rack of claim 32, wherein each arm of the second pair of arms telescopes between a retracted position and an expanded position.

34. The rack of claim 27, wherein the crossbar includes a middle portion between first and second ends, the middle portion of the crossbar being connected to the mast by a rotatable joint.

35. The rack of claim 34, wherein the second pair of arms are connected to the crossbar on either side of the rotatable joint.

36. A rack for carrying recreational equipment on a vehicle, comprising:
a stinger receivable by a hitch receiver behind a vehicle;
a fixed bar extending perpendicular to the stinger, and fixed to the stinger;
a pivotable bar, having a first end connected to the fixed bar by a pivot joint, wherein a second end of the pivotable bar is releasably securable to the fixed bar when the pivotable bar is in a closed position;
a first pair of arms, extending from the pivotable bar and configured to support a first recreational equipment carrier;
a mast, having a lower end portion connected to the pivotable bar;
a crossbar having a middle portion connected to the mast by a rotatable joint, the rotatable joint including an upper sleeve fixed to the crossbar and receiving an end of the mast; and
a second pair of arms, extending from the crossbar and configured to support a second recreational equipment carrier.

37. The rack of claim 36, wherein the upper sleeve engages a splined end of the mast.

38. The rack of claim 36, wherein the crossbar is rotatable between a transport position and an access position.

39. The rack of claim 38, wherein the upper sleeve includes a first engaging fin and the mast includes second and third engaging fins.

40. The rack of claim 39, wherein the first engaging fin contacts the second engaging fin in the transport position, and the first engaging fin contacts the third engaging fin in the access position.
